(19) United States
(12) Patent Application Publication
(10) Pub. No.: US 2018/0113764 A1
(43) Pub. Date: Apr. 26, 2018

(54) Hypervisor Based Watchdog Timer

(71) Applicant: Microsoft Technology Licensing, LLC, Redmond, WA (US)

(72) Inventors: Aditya Bhandari, Redmond, WA (US); Kenneth D. Johnson, Bellevue, WA (US); Cody Dean Hartwig, Sammamish, WA (US); Bruce J. Sherwin, JR., Woodinville, WA (US); Jason S. Wohlgemuth, Seattle, WA (US)

(73) Assignee: Microsoft Technology Licensing, LLC, Redmond, WA (US)

(21) Appl. No.: 15/332,981

(22) Filed: Oct. 24, 2016

(51) Int. Cl. G06F 11/14; G06F 11/07

(52) U.S. Cl. CPC G06F 11/1441; G06F 11/079; G06F 11/0757; G06F 11/0706

(57) ABSTRACT

A computing device runs a hypervisor that manages a watchdog timer, referred to as a hypervisor watchdog timer, for each operating system in each partition. Each hypervisor watchdog timer is re-armed at various intervals by the operating system running in the associated partition. In response to a hypervisor watchdog timer expiring, the watchdog timer resets the operating system in the associated partition. Optionally, after a threshold amount of time elapses without being re-armed, the hypervisor watchdog timer issues a non-maskable interrupt (NMI) to the operating system in the associated partition to allow the operating system to store crash data. Operation of the hypervisor watchdog timers is paused when the computing device enters a low power mode and resumes when the computing device exits the low power mode, removing any need to re-arm the hypervisor watchdog timers while the computing device is in the low power mode.

### BACKGROUND

As computing technology has advanced, computer components and computer programs have become increasingly complex. This increased complexity provides many performance and functionality benefits to users, but is not without its problems. One such problem is that bugs or problems with the components or programs can result in situations in which a computing device hangs, not progressing with program execution as intended. This can lead to user frustration with their devices due to draining the battery of the device, the need to reset their devices, and so forth.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a hypervisor is run on a computing device, the hypervisor managing one or more partitions on the computing device, each of the one or more partitions running an operating system. A hypervisor watchdog timer associated with a partition is re-armed in response to a re-arm request from an operating system in the partition. If the hypervisor watchdog timer expires, the operating system is reset. If the computing device enters a low power mode, the hypervisor watchdog timer is paused and resumed when the computing device exits the low power mode.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example computing device implementing the hypervisor based watchdog timer in accordance with one or more embodiments.

FIG. 2 is a block diagram illustrating another example computing device implementing the hypervisor based watchdog timer in accordance with one or more embodiments.

FIG. 3 is a flowchart illustrating an example process for implementing the hypervisor based watchdog timer in accordance with one or more embodiments.

FIG. 4 is a flowchart illustrating another example process for implementing the hypervisor based watchdog timer in accordance with one or more embodiments.

FIG. 5 illustrates an example system that includes an example computing device that is representative of one or more systems and/or devices that may implement the various techniques described herein.

### DETAILED DESCRIPTION

A hypervisor based watchdog timer is discussed herein. A computing device runs a hypervisor, which is a virtualization platform that allows multiple isolated operating systems to share a single hardware platform. The hypervisor generates one or more partitions and the operating system running in each partition is isolated from the operating systems running in other partitions.

The hypervisor provides a watchdog timer to each operating system in each partition. A watchdog timer generally refers to functionality including a timer that expires after a particular amount of time has elapsed, such as 5 minutes, and causes an operating system to reset in response to the timer expiring. A watchdog timer provided by the hypervisor is also referred to herein as a hypervisor watchdog timer. The hypervisor watchdog timer is a watchdog timer associated with a particular partition of the hypervisor, and a separate hypervisor watchdog timer is provided for each partition. In response to a hypervisor watchdog timer expiring, the watchdog timer resets the operating system in the associated partition. In order to avoid a hypervisor watchdog timer expiring, the operating system in the associated partition re-arms the hypervisor watchdog timer prior to the hypervisor watchdog timer expiring. If the operating system is operating correctly, the operating system repeatedly re-arms the hypervisor watchdog timer (e.g., every 1 to 2 minutes), keeping the hypervisor watchdog timer from resetting the operating system. However, if the operating system is not operating correctly and hangs, the hypervisor watchdog timer expires, causing the malfunctioning operating system to be reset. Resetting the malfunctioning operating system avoids battery drain that may result from prolonged operation of an incorrectly functioning operating system.

In one or more embodiments, after a threshold amount of time elapses (e.g., 2½ minutes), if not re-armed (also referred to as reset) the hypervisor watchdog timer issues a non-maskable interrupt (NMI) to the operating system in the associated partition. A non-maskable interrupt cannot be blocked by the operating system when the operating system is functioning correctly (unless the operating system is already processing another non-maskable interrupt). The hypervisor watchdog timer issues the NMI because it has not been re-armed as expected and thus is expecting that it will expire and reset the operating system associated with the hypervisor watchdog timer. In response to the NMI, if the operating system is functioning correctly the operating system can take various actions, such as writing crash data (e.g., various data in the memory, state information for the operating system, register values, and so forth) to a storage device. This crash data allows diagnostics to be later performed to attempt to determine why the operating system ceased functioning correctly.

The techniques discussed herein allow the expiration amount of time for the hypervisor watchdog timers to be set to relatively short durations (e.g., 5 minutes or less). A malfunctioning (e.g., hung) operating system does not keep the computing device 100 from entering a low power mode for greater than the expiration amount of time because the operating system will be reset. This reduces power consumption in the computing device 100 in the event of a malfunctioning operating system. Furthermore, by issuing the non-maskable interrupt within a short amount of time (e.g., 2½ minutes), the operating system is more likely to be able to write crash data before the user attempts to hard reset (e.g., by pressing the power button) the computing device 100 (at which point writing the crash data is typically not possible).

Each partition has an associated hypervisor watchdog timer, so the operating system in each partition re-arms the associated hypervisor watchdog timer. If one hypervisor watchdog timer expires, the operating system associated with that hypervisor watchdog timer is reset. However, the operating systems associated with other hypervisor watchdog timers that have not expired are not reset.

The hypervisor provides the watchdog timers without relying on any hardware watchdog timer for the computing device. Thus, watchdog timers are made available to the operating systems running on the hypervisor even if the hardware platform on which the hypervisor runs does not provide a watchdog timer.

In some situations, such as when operating in a connected standby or other low power mode, execution of the hypervisor may be paused. Execution of a paused hypervisor can resume in response to various different events or activities, such as a device interrupt (e.g., resulting from a user pushing a power button of the device, or receipt of an external communication such as a phone call). When the execution of the hypervisor is paused, the hypervisor watchdog timers are also paused. Thus, there is no need for the computing device to be brought out of its low power mode in order to re-arm the watchdog timers (e.g., every 1 to 2 minutes). Rather, the computing device can remain in its low power mode for longer than the particular amount of time that it takes for a hypervisor watchdog timer to expire (e.g., longer than 5 minutes) without fear of the hypervisor watchdog timer expiring and causing the operating system in one of the partitions to be reset.

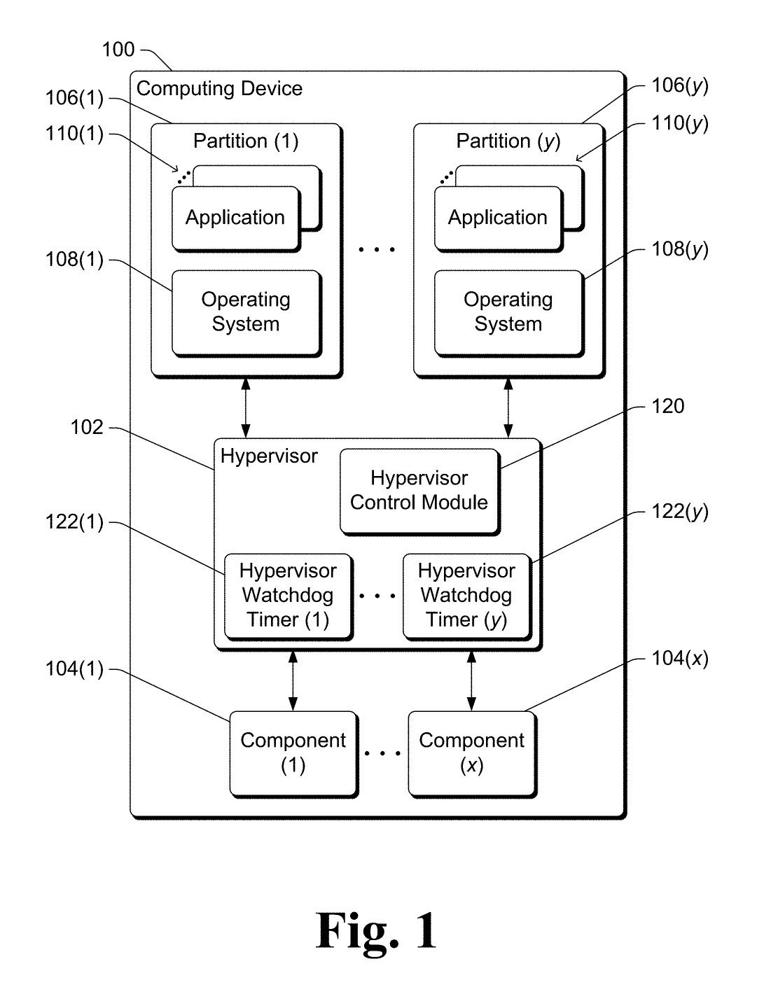

FIG. 1 is a block diagram illustrating an example computing device 100 implementing the hypervisor based watchdog timer in accordance with one or more embodiments. The computing device 100 can be a variety of different types of devices. For example, the computing device 100 can be a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet, augmented reality (AR) devices, virtual reality (VR) devices), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the computing device 100 may range from a full-resource device with substantial memory and processor resources (e.g., personal computers, game consoles) to a low-resource device with limited memory and/or processing resources (e.g., traditional set-top boxes, hand-held game consoles).

The computing device 100 includes a hypervisor 102 and at least one (shown as multiple (x)) components 104. The hypervisor is a virtual machine monitor that manages access to the functionality provided by the components 104. The components 104 can be a variety of different physical components, such as processor components, input/output (I/O) components, and/or other components or devices. For example, the components 104 can include one or more processors or processor cores, one or more memory components (e.g., volatile and/or nonvolatile memory), one or more storage devices (e.g., optical and/or magnetic disks, flash memory drives), one or more communication components (e.g., wired and/or wireless network adapters), combinations thereof, and so forth. Although illustrated as part of the computing device 100, one or more components 104 (e.g., one or more storage devices) can be implemented external to the computing device 100. Various components or modules running on the computing device 100, including hypervisor 102, can access this functionality managed by components 104 directly and/or indirectly via other components or modules.

The hypervisor 102 generates at least one (shown as multiple (y)) partitions 106. Each partition 106 can also be referred to as a virtual machine (VM). In one or more embodiments one of the partitions 106 (e.g., the first partition created by the hypervisor 102) is a root or parent partition and the other partitions 106 are referred to as guest partitions. Each partition 106 is a logical unit of isolation within which an operating system runs. The operating systems running within the partitions 106 are isolated from each other. Similarly, the applications running within the partitions 106 are isolated from applications running in other partitions 106. The operating system and applications running in one partition 106 are not able to access, and need not be aware of, the operating systems and applications running in the other partitions 106. The components 104 are virtualized to the partitions 106, and access to the components 104 is managed by the hypervisor 102.

Each partition 106 includes an operating system 108 and one or more applications 110. Each partition 106 can run a different instance of the same operating system (e.g., one of the Windows® family of operating systems) and/or different partitions 106 can run different operating systems. Similarly, each partition 106 can run a different instance of the same application and/or different partitions 106 can run different applications.

The hypervisor 102 includes a hypervisor control module 122 and at least one (shown as multiple (y)) hypervisor watchdog timer 122. The hypervisor control module 120 manages the access to components 104 by the operating system 108. Each hypervisor watchdog timer 122 is associated with one partition 106. The hypervisor watchdog timer 122 has an associated expiration amount of time. In one or more embodiments, the expiration amount of time is 5 minutes, although other amounts of time can alternatively be used. The operating system 108 of a partition 106 arms the associated hypervisor watchdog timer 122. Arming the hypervisor watchdog timer 122 refers to informing the hypervisor watchdog timer 122 to begin its timing (e.g., counting down to zero), and optionally the expiration amount of time for the hypervisor watchdog timer 122 to use.

The operating system 108 in the partition 106 associated with a particular hypervisor watchdog timer 122 re-arms the hypervisor watchdog timer 122 at some regular or irregular interval. In one or more embodiments, the operating system 108 re-arms the hypervisor watchdog timer 122 at an interval that is one fourth of the expiration amount of time. For example, if the expiration amount of time is 5 minutes, then the operating system can re-arm the hypervisor watchdog timer 122 every 1.25 minutes. The amount of time that elapses between each re-arming of the hypervisor watchdog timer 122 is also referred to as the re-arm amount of time. By re-arming the hypervisor watchdog timer 122, the hypervisor watchdog timer 122 does not expire.

If a hypervisor watchdog timer 122 expires (e.g., the expiration amount of time elapses without the hypervisor watchdog timer 122 being re-armed), then the hypervisor watchdog timer 122 resets the operating system 108 in the associated partition 106. Resetting the operating system 108 refers to restarting the operating system 108, and can be performed in various manners. In one or more embodiments, execution of the operating system 108 is terminated and restarted (e.g., the operating system 108 is re-booted, analogous to power cycling a physical system). Additionally or alternatively, the operating system 108 can be reset in other manners, such as by deleting the associated partition and creating a new partition running the operating system 108.

In one or more embodiments, if the hypervisor watchdog timer 122 associated with a partition 106 that is a root partition expires, then resetting the operating system 108 refers to resetting the computing device 100. The computing device 100 can be reset in various manners, such as by asserting a hardware reset pin of one or more processors of the computing device 100. Thus, if the hypervisor watchdog timer 122 associated with a root partition expires, the root partition as well as all the other partitions 106 (and the hypervisor 102 and the entire computing device 100) are reset as well. However, if the hypervisor watchdog timer 122 associated with a partition 106 that is a guest partition (e.g., not a root partition) expires, then resetting the operating system refers to restarting the operating system 108 but not restarting the operating systems of other partitions 106 (and not resetting the computing device 100).

In one or more embodiments, each partition 106 has its own associated hypervisor watchdog timer 122 that is associated with that partition 106 and no other partition 106. Alternatively, in some embodiments each partition 106 chooses whether to have an associated hypervisor watchdog timer, and if a partition chooses not to have an associated hypervisor watchdog timer then there is no hypervisor watchdog timer 122 associated with such a partition. Additionally or alternatively, in some embodiments the same hypervisor watchdog timer may be associated with multiple partitions 106.

By maintaining separate hypervisor watchdog timers 122 for the separate partitions 106, situations can arise in which one hypervisor watchdog timer 122 expires but another hypervisor watchdog timer 122 does not expire. In such situations, the operating system 108 in the partition 106 associated with the hypervisor watchdog timer 122 that has expired is reset, but the operating systems 108 in other partitions 106 associated with hypervisor watchdog timers 122 that have not expired are not reset.

In one or more embodiments, the hypervisor watchdog timer 122 also issues a non-maskable interrupt (NMI) to the operating system 108 of the associated partition 106 after a particular amount of time, also referred to as an interrupt amount of time. This particular amount of time is a significant portion of the expiration amount of time for the hypervisor watchdog timer 122. This significant portion of the expiration amount of time is an amount of time that is less than the expiration amount of time for the hypervisor watchdog timer 122 but greater than the amount of time after which the hypervisor watchdog timer 122 expects to be re-armed. In one or more embodiments, this significant portion of the expiration amount time is one half of the expiration amount of time. For example, if the expiration amount of time is 5 minutes and the operating system is expected to re-arm the hypervisor watchdog timer 122 every 1.25 minutes, then this significant portion of the expiration amount of time is 2.5 minutes. This significant portion of the expiration amount of time can vary, and can optionally be provided to the hypervisor watchdog timer 122 by the operating system 108 in the associated partition 106.

The NMI is an interrupt that cannot be blocked by the operating system 108. The NMI from the hypervisor watchdog timer 122 serves as a warning to the operating system 108 that the hypervisor watchdog timer 122 has not been re-armed, and that the hypervisor watchdog timer 122 is likely to reset the operating system 108 soon. The operating system 108 does not receive the NMI unless the operating system 108 has not re-armed the hypervisor watchdog timer 122, so the operating system 108 can assume that it will be reset soon.

The operating system 108 re-arms the hypervisor watchdog timer 122 when functioning properly, so if the NMI is received the operating system 108 can assume that the operating system 108 is malfunctioning in some manner. Accordingly, in response to the NMI the operating system 108 attempts to write crash data to a storage device. The crash data can include any of a variety of different information regarding the status or state of the operating system 108 or the computing device 100 as seen by the operating system 108. The crash data can include, for example, the values stored in locations of memory, processor register settings, current preferences or other settings of the operating system 108 and/or applications 110 in the same partition 106, and so forth. The crash data is diagnostic data that can be used during subsequent analysis to attempt to determine what is malfunctioning in the operating system 108 and/or application 110 in the same partition. The storage device can be an internal storage device (e.g., disk drive) of the computing device 100, or alternatively can be a storage device coupled to the computing device 100 (e.g., via a wired or wireless connection to the computing device 100, via a network, and so forth).

Although writing crash data is discussed herein as being performed in response to the NMI, additionally or alternatively various other actions can be taken in response to the NMI. For example, the hypervisor watchdog timer can be re-armed in response to the NMI.

In one or more embodiments, the NMI cannot be blocked by the operating system 108 (unless the operating system 108 is already processing another NMI), so if the operating system 108 is stuck in some manner it is possible that the NMI can still be serviced by the operating system 108. However, situations can arise in which the operating system 108 is malfunctioning badly enough that the operating system 108 is not able to service the NMI. In such situations, the operating system is not able to write crash data to a storage device.

In some situations, an NMI is not supported by the computing device 100. For example, if the computing device 100 is using an ARM (Advanced RISC (Reduced Instruction Set Computing) Machine) or ARM64 architecture, NMIs are not supported. In such situations, other “high priority” interrupts can be issued instead of NMIs. These high priority interrupts are issued analogous to the NMIs discussed herein. Such a high priority interrupt typically has a greater chance of not being blocked by the operating system 108 than a normal (lower priority) interrupt, although may not have as a great a chance of not being blocked by the operating system 108 as an NMI.

In one or more embodiments, the hypervisor 102 provides additional crash data collection. In such embodiments, if the operating system 108 in a partition 106 is reset, the hypervisor 102 stores additional crash data regarding the operating system 108 and/or the partition 106. This crash data can be any state or status information for the partition 106 and/or the computing device 100 that the hypervisor 102 has access to. This crash data can be stored on various storage devices included as part of the computing device 100 and/or coupled to the computing device 100 as discussed above.

In one or more embodiments, each hypervisor watchdog timer 122 supports start and stop requests from the operating system 108 in the associated partition 106. The operating system 108 in a partition 106 can determine whether to have watchdog timer functionality implemented for the operating system 108. This determination can be made in various manners, such as based on policy applied by the operating system 108, based on user settings or preferences, and so forth. The operating system 108 can issue a start request to the hypervisor watchdog timer 122 to have the watchdog timer functionality started, and a stop request to have the watchdog timer functionality stopped.

In addition to the start and stop requests, a pause functionality for the watchdog timer is also supported by the hypervisor 102. In one or more embodiments, the computing device 100 supports various different low power modes in which execution of programs on the computing device 100 ceases for an amount of time in order to conserve energy usage by the computing device 100. These low power modes can be, for example, a connected standby mode for the computing device 100.

The pausing of the hypervisor watchdog timers 122 can be performed in a variety of different manners. In one or more embodiments, the hypervisor 102 is notified by a power management module or component of the computing device 100 that the computing device 100 is in the process of entering the low power mode, and in response the hypervisor control module 120 pauses each hypervisor watchdog timer 122, causing the hypervisor watchdog timers 122 to temporarily cease their timing functionality (e.g., counting down). When the computing device exits the low power mode, the power management module or component of the computing device 100 that the computing device 100 notifies the hypervisor 102 that the computing device 100 is in the process of existing the low power mode, and in response the hypervisor control module 120 resumes each hypervisor watchdog timer 122, causing the hypervisor watchdog timers 122 to resume their timing functionality (e.g., counting down). The hypervisor watchdog timers 122 can resume their timing functionality from where they were (e.g., if a hypervisor watchdog timer had counted down from 5 minutes to 4 minutes when paused, upon resuming the hypervisor watchdog timer continues counting down from 4 minutes). Alternatively, the hypervisor watchdog timers can be re-armed (e.g., set to the expiration amount of time), effectively re-arming each hypervisor watchdog timer upon exiting the low power mode.

Alternatively, the pausing of the hypervisor watchdog timers 122 can be performed in other manners. For example, the hypervisor 102 can be implemented in software code, and thus execution of the code implementing the hypervisor 102 ceases while the computing device 100 is in the low power mode. Thus, the hypervisor watchdog timers 122, which are part of the code implementing the hypervisor 102, are inherently paused while the computing device 100 is in the low power mode. When the computing device 100 exits the low power mode, execution of the code implementing the hypervisor 102 resumes and the hypervisor watchdog timers 122 also resume their timing functionality.

The hypervisor watchdog timers 122 are effectively paused while the computing device 100 is in a low power mode. While paused, the hypervisor watchdog timers 122 are not counting to determine whether the expiration amount of time has elapsed. When the computing device 100 exits the low power mode the hypervisor watchdog timers 122 resume their timer functionality counting to determine whether the expiration amount of time has elapsed as discussed above. In one or more embodiments, as part of entering a low power mode the state of the hypervisor 102 is saved and this state includes the settings for the hypervisor watchdog timer 122. Thus, when the computing device 100 exits the low power mode, the state of the hypervisor 102 including the settings for the hypervisor watchdog timers 122 (e.g., and how much time is left until the hypervisor watchdog timers 122 expire) is restored.

Pausing the hypervisor watchdog timers 122 allows the computing device 100 to be placed into a low power mode for extended periods of time, including times longer than the expiration amount of time for each of the hypervisor watchdog timers 122. The hypervisor watchdog timers 122 are not counting towards their expiration amounts of time while the computing device 100 is in the low power mode, so the operating system 108 need not re-arm the hypervisor watchdog timers 122. The computing device 100 thus need not exit from its low power mode just to re-arm the hypervisor watchdog timers 122. This allows the computing device 100 to remain in the low power mode longer, conserve energy, and reduce battery drain of the computing device 100.

The hypervisor watchdog timers 122 can also be stopped or paused at other times. For example, if the operating system 108 of a partition 106 detects that a debugger has been activated in the partition 106, then the operating system 108 stops or pauses the hypervisor watchdog timer 122 associated with that partition 106. This stopping or pausing allows the debugger to operate without concern for the hypervisor watchdog timer resetting the operating system because, due to the use of the debugger, the request to re-arm the hypervisor watchdog timer is not made.

It should be noted that the hypervisor watchdog timers 122 are implemented in the hypervisor 102 in the example of FIG. 1. The hypervisor watchdog timers 122 do not rely on any hardware watchdog timer for the computing device 100, and the computing device 100 need not include any hardware watchdog timer. The techniques discussed herein thus provide watchdog timer support to operating systems in the partitions 106 without there needing to be any hardware watchdog timer in the computing device 100.

Furthermore, the techniques discussed herein allow for the collection of crash data, which allows diagnostics to be later performed to attempt to determine why the operating system ceased functioning correctly as discussed above. This crash data can be stored in response to a non-maskable interrupt issued by a hypervisor watchdog timer, and does not rely on any hardware watchdog timer. Thus, the techniques discussed herein support diagnosing operating system malfunctions (e.g., hangs) on computing devices that do not have a hardware (physical) watchdog timer.

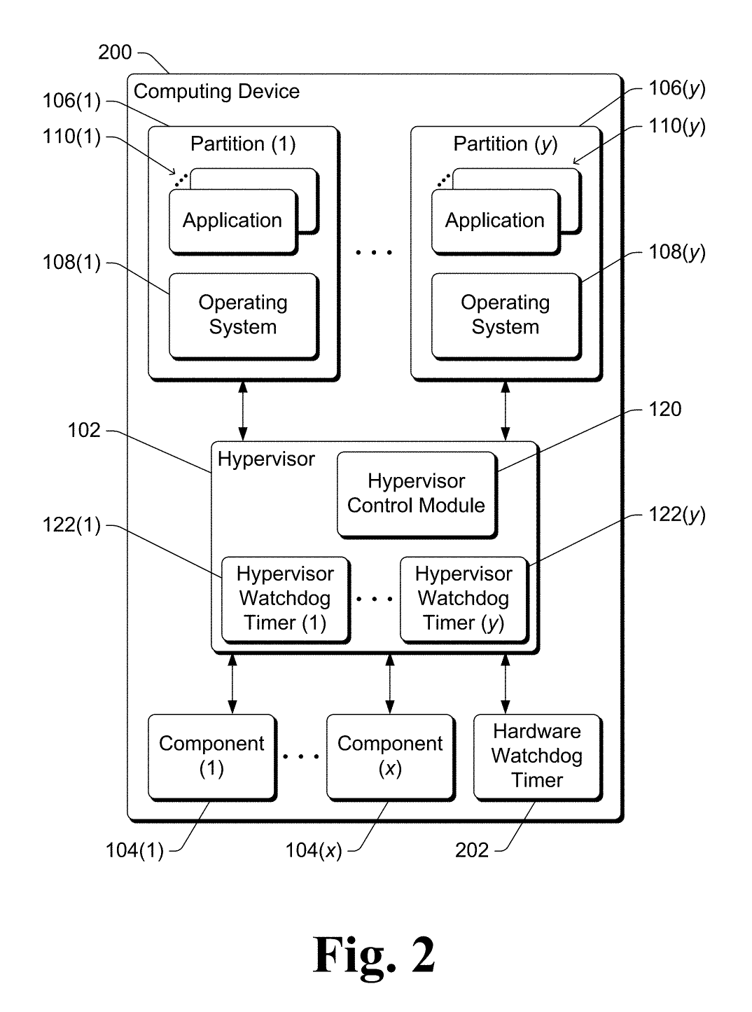

FIG. 2 is a block diagram illustrating an example computing device 200 implementing the hypervisor based watchdog timer in accordance with one or more embodiments. The computing device 200 can be a variety of different types of devices, analogous to the discussion of computing device 100 above. Computing device 200 is similar to computing device 100 of FIG. 1, but differs in that computing device 200 includes a hardware watchdog timer 202. The hardware watchdog timer 202 can be implemented in various manners, such as part of a chipset in the computing device 100.

The computing device 200 includes components 104 and a hypervisor 102 with a hypervisor control module 120 and hypervisor watchdog timers 122 as discussed above. The computing device 200 also includes at least one partition 106, each partition 106 running an operating system 108 and at least one application 110 as discussed above. Each hypervisor watchdog timers 122 is associated with a partition 106, and is armed and re-armed by an operating system 108 of the associated partition 106, and resets the operating system 108 in the associated partition if the hypervisor watchdog timer 122 expires as discussed above.

The hardware watchdog timer 202 operates as a watchdog timer to the hypervisor 102. The hardware watchdog timer 202 is armed and re-armed by the hypervisor control module 120, analogous to the arming and re-arming of a hypervisor watchdog timer 122 by an operating system 108. If the hardware watchdog timer 202 expires, the hardware watchdog timer 202 resets the hypervisor 102. The hypervisor watchdog timer 202 can reset the hypervisor 102 in various manners, such as by issuing a hardware reset in the computing device 100 (e.g., asserting a hardware reset pin of one or more processors of the computing device 100).

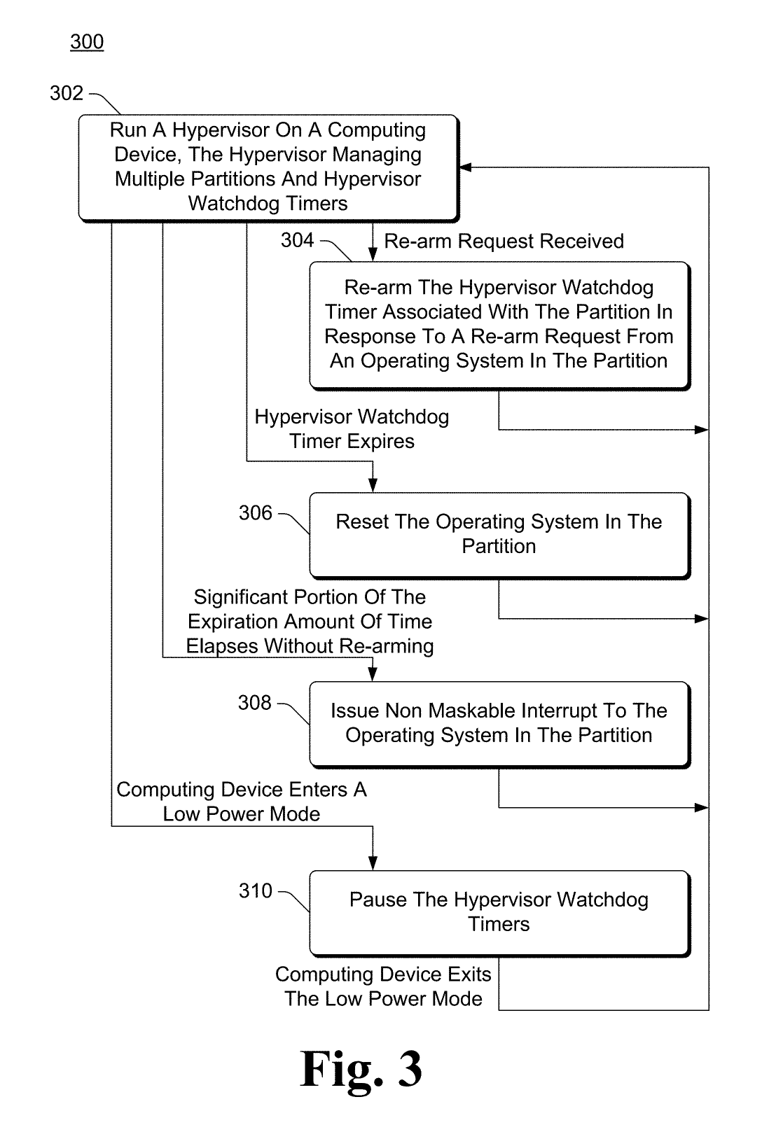

FIG. 3 is a flowchart illustrating an example process 300 for implementing the hypervisor based watchdog timer in accordance with one or more embodiments. Process 300 is carried out by a computing device, such as computing device 100 of FIG. 1 or computing device 200 of FIG. 2, and can be implemented in software, firmware, hardware, or combinations thereof. Process 300 is shown as a set of acts and is not limited to the order shown for performing the operations of the various acts. Process 300 is an example process for implementing the hypervisor based watchdog timer; additional discussions of implementing the hypervisor based watchdog timer are included herein with reference to different figures.

In process 300, a hypervisor is run on the computing device (act 302). The hypervisor manages multiple partitions on the computing device, each of which runs a different instance of an operating system, whether the same or different operating systems. The hypervisor also manages multiple hypervisor watchdog timers, each hypervisor watchdog timer being associated with one of the multiple partitions.

While running the hypervisor, the hypervisor watchdog timers count for a particular amount of time (e.g., starting from the expiration amount of time, such as 5 minutes, counting down towards zero). Various different actions can be taken by the hypervisor watchdog timer based on various events occurring, such as a re-arm request being received for a hypervisor watchdog timer, a hypervisor watchdog timer expiring, a significant portion of the expiration amount of time (e.g., at least half of the expiration amount of time) has elapsed, and the computing device entering a low power mode.

In response to a re-arm request from an operating system of a partition, the hypervisor watchdog timer associated with that partition is re-armed (act 304). Re-arming the hypervisor watchdog timer refers to resetting the hypervisor watchdog timer to the expiration amount of time (e.g., 5 minutes). Process 300 continues to run the hypervisor, including running (e.g., counting down) the hypervisor watchdog timers (act 302).

In response to a hypervisor watchdog timer expiring, the operating system in the partition associated with the expired hypervisor watchdog timer is reset (act 306). Resetting the operating system in the partition can be performed in various manners as discussed above. Process 300 continues to run the hypervisor, including running (e.g., counting down) the hypervisor watchdog timers (act 302).

In response to a significant portion of the expiration amount of time having elapsed for a particular hypervisor watchdog timer, a non-maskable interrupt is issued to the operating system in the partition associated with the particular hypervisor watchdog timer (act 308). The non-maskable interrupt serves as a warning to the operating system that the hypervisor watchdog timer has not been re-armed, and resetting of the operating system is imminent as discussed above. Process 300 continues to run the hypervisor, including running (e.g., counting down) the hypervisor watchdog timers (act 302).

In response to the computing device entering a low power mode, the hypervisor watchdog timers managed by the hypervisor are paused as part of the process of entering the low power mode (act 310). Pausing the hypervisor watchdog timers allows the computing device to enter a low power mode without concern for exiting the low power mode in order to re-arm the hypervisor watchdog timers. The hypervisor watchdog timers remain paused for as long as the computing device is in the low power mode. In response to the computing device exiting the low power mode, process 300 continues to run the hypervisor, including running (e.g., counting down) the hypervisor watchdog timers (act 302).

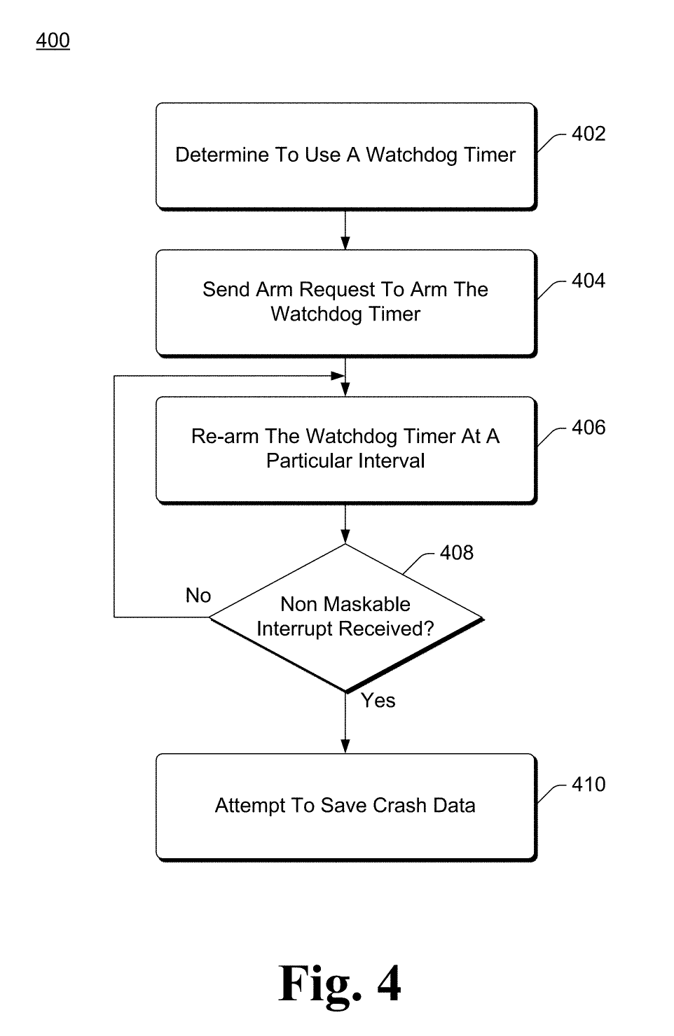

FIG. 4 is a flowchart illustrating an example process 400 for implementing the hypervisor based watchdog timer in accordance with one or more embodiments. Process 400 is carried out by a component or module of a computing device, such as an operating system 108 of FIG. 1 or FIG. 2, or a hypervisor 102 of FIG. 1 or FIG. 2. Process 400 can be implemented in software, firmware, hardware, or combinations thereof. Process 400 is shown as a set of acts and is not limited to the order shown for performing the operations of the various acts. Process 400 is an example process for implementing the hypervisor based watchdog timer; additional discussions of implementing the hypervisor based watchdog timer are included herein with reference to different figures.

In process 400, a determination is made to use a watchdog timer (act 402). The determination is made by the operating system to use a hypervisor watchdog timer, or by the hypervisor to use a hardware watchdog timer. This determination can be programmed into the operating system or hypervisor, or alternatively can be a preference or usage setting (e.g., determined based on user input, based on policy applied to the computing device, etc.).

A request is sent to arm the watchdog timer (act 404). The request is sent by the operating system to arm a hypervisor watchdog timer associated with a partition in which the operating system runs, or by the hypervisor to arm a hardware watchdog timer.

A request is also sent to re-arm the watchdog timer (act 406). The request to re-arm the watchdog timer is sent after a re-arm amount of time has elapsed since the watchdog timer was armed or last re-armed. The re-arm amount of time can vary, and in one or more embodiments is one fourth of the expiration amount of time as discussed above. The request to re-arm the watchdog timer is sent by the operating system to re-arm a hypervisor watchdog timer associated with a partition in which the operating system runs, or by the hypervisor to re-arm a hardware watchdog timer.

Process 400 proceeds based on whether a non-maskable interrupt has been received (act 408). The non-maskable interrupt serves as a warning that the watchdog timer has not been re-armed, and resetting of the operating system or the hypervisor is imminent as discussed above. The non-maskable interrupt is received by the operating system from the hypervisor watchdog timer associated with the partition in which the operating system runs, or by the hypervisor from the hardware watchdog timer.

If a non-maskable interrupt is not received, re-arming the watchdog timer at a particular interval continues (act 406). However, if at any time a non-maskable interrupt is received, an attempt is made to save crash data (act 410). The crash data is various status or state of the operating system, the hypervisor, and/or the computing device. In one or more embodiments, the crash data is saved by whichever of the operating system and the hypervisor receives the non-maskable interrupt. For example, if the non-maskable interrupt is received from a hypervisor watchdog timer, then the operating system that receives the non-maskable interrupt attempts to save the crash data. However, if the non-maskable interrupt is received from a hardware watchdog timer, then the hypervisor attempts to save the crash data. Alternatively, one of the operating systems can attempt to save the crash data (e.g., an operating system running in a root partition).

It should be noted that in act 410 an attempt is made to save crash data. The non-maskable interrupt cannot be blocked, so it is possible that malfunctioning of the operating system or hypervisor that caused the watchdog timer to not be re-armed does not affect the handling of the non-maskable interrupt, in which case the crash data can typically be saved. However, situations can arise in which the operating system or hypervisor is prevented from handling the non-maskable interrupt, in which case the crash data is typically not saved. Such situations can arise, for example, due to hardware problems (e.g., a processor being stuck trying to access the system bus), malfunctioning of the operating system or hypervisor, and so forth.

Returning to FIG. 1, in one or more embodiments when a partition 106 is created, the partition 106 enumerates capabilities that the hypervisor 102 offers. These capabilities are also referred to as enlightenments. Each partition 106 notifies the operating system 108 running in that partition 106 of the capabilities that are available to the operating system 108, and these capabilities include the watchdog timer functionality. This capability can be identified, for example, by the hypervisor 102 setting a bit available via the CPUID instruction for the x86 processor architecture, such as a bit:
HV_X64 _HYPERVISOR FEATURES.WatchdogTimerAvailable

The interface to the hypervisor watchdog timers 122 can be provided in any of a variety of different manners. In one or more embodiments, the interface to the hypervisor watchdog timers 122 is provided to the operating systems 110 via a processor control register, such as a model-specific register (MSR). Examples of these control registers are:
HV_X64 _MSR_SWATCHDOG_CONFIG
HV_X64 _MSR_SWATCHDOG_COUNT
HV_X64 _MSR_SWATCHDOG_STATUS

The HV_X64_MSR_SWATCHDOG_CONFIG register includes an Enable bit, an AutoEnable bit, and multiple (e.g., 62) reserved bits. The Enable bit can be set to one value (e.g., 1) to indicate that the hypervisor watchdog timer is enabled (e.g., setting the Enable to 1 is a request to start the hypervisor watchdog timer), and another value (e.g., 0) to indicate that the hypervisor watchdog timer is not enabled (e.g., setting the Enable to 0 is a request to stop the hypervisor watchdog timer). The AutoEnable bit can be set to one value (e.g., 1) to indicate that a write to the HV_X64_MSR_SWATCHDOG_COUNT register will enable the timer without having to write the HV_X64_MSR_SWATCHDOG_CONFIG register, and another value to indicate that a write to the HV_X64_MSR_SWATCHDOG_COUNT register will not enable the timer without having to write the HV_X64_MSR_SWATCHDOG_CONFIG register.

The HV_X64_MSR_SWATCHDOG_COUNT accepts an amount of time that is the expiration amount of time for the hypervisor watchdog timer. This value can be represented in various units, such as 100 nanosecond units.

The HV_X64_MSR_SWATCHDOG_STATUS register indicates whether a non-maskable interrupt has been issued as a result of a significant portion of the expiration amount of time (e.g., at least half of the expiration amount of time) elapsing. In other words, the HV_X64_MSR_SWATCHDOG_STATUS register indicates whether the hypervisor watchdog timer is the source of the non-maskable interrupt. The hypervisor watchdog timer sets the HV_X64_MSR_SWATCHDOG_STATUS register when the hypervisor watchdog timer issues the non-maskable interrupt. The HV_X64_MSR_SWATCHDOG_STATUS register being set to one value (e.g., 1) indicates that the hypervisor watchdog timer has asserted the non-maskable interrupt, and the HV_X64_MSR_SWATCHDOG_STATUS register being set to another value (e.g., 0) indicates that the hypervisor watchdog timer has not asserted the non-maskable interrupt. If the hypervisor watchdog timer has issued the non-maskable interrupt, then the operating system 122 acknowledges the outstanding non-maskable interrupt by writing the other value (e.g., 0) to the HV_X64_MSR_SWATCHDOG_STATUS register. If the hypervisor watchdog timer expires while the HV_X64_MSR_SWATCHDOG_STATUS register is set to the one value (e.g., 1), then the operating system is reset. The HV_X64_MSR_SWATCHDOG_STATUS register still being set to the one value (e.g., 1) when the hypervisor watchdog timer expires provides confirmation to the hypervisor watchdog timer that the operating system is malfunctioning and is unable to acknowledge the non-maskable interrupt issued by the hypervisor watchdog timer.

It should be noted that various additional control registers can also be implemented. For example, an additional control register can be included that specifies the target of the non-maskable interrupt.

In the discussions herein, a hypervisor watchdog timer associated with a partition is described. Additionally or alternatively, multiple hypervisor watchdog timers can be associated with a single partition. For example, returning to FIG. 1, the hypervisor 102 may support multiple virtual trust levels. Each virtual trust level refers to a different trust level or mode in which a partition 106 can be run, and the mode trust level or mode can be changed during operation of the partition 106. Different memory access protections can be associated with different virtual trust levels, limiting what memory can be accessed and/or how the memory can be accessed when the partition is running in each virtual trust level. Different virtual processor state can also be associated with different virtual trust levels, preventing one virtual trust level from accessing at least some of the processor state of another virtual trust level. The virtual trust levels are organized as a hierarchy with a higher level virtual trust level being more privileged than a lower virtual trust level, and programs running in the higher virtual trust level being able to change memory access protections of a lower virtual trust level, but programs running in the lower virtual trust level being unable to change memory access protections of a higher virtual trust level.

Each virtual trust level for a given partition 106 can also have an associated hypervisor watchdog timer, so multiple hypervisor watchdog timers can be associated with the given partition 106. The different hypervisor watchdog timers associated with the different virtual trust levels of a partition 106 operate analogously to the other hypervisor watchdog timers discussed herein, except that operations for a particular hypervisor watchdog timer are taken by programs running at the virtual trust level in the partition. For example, an NMI issued by a hypervisor watchdog timer is handled by a program running in the virtual trust level associated with the hypervisor watchdog timer that issued the NMI.

Various actions can be taken in response to expiration of a hypervisor watchdog timer associated with a particular virtual trust level. For example, the operating system in the partition 106 can be reset if any hypervisor watchdog timer associated with any virtual trust level of the partition 106 expires. By way of another example, a virtual trust level of a partition 106 can be reset (e.g., the virtual trust level can be deleted and restarted, programs running in that virtual trust level can be terminated and restarted, etc.) in response to expiration of the hypervisor watchdog timer associated with that virtual trust level, but other virtual trust levels in that partition 106 that are not associated with the expired hypervisor watchdog timer are not reset.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

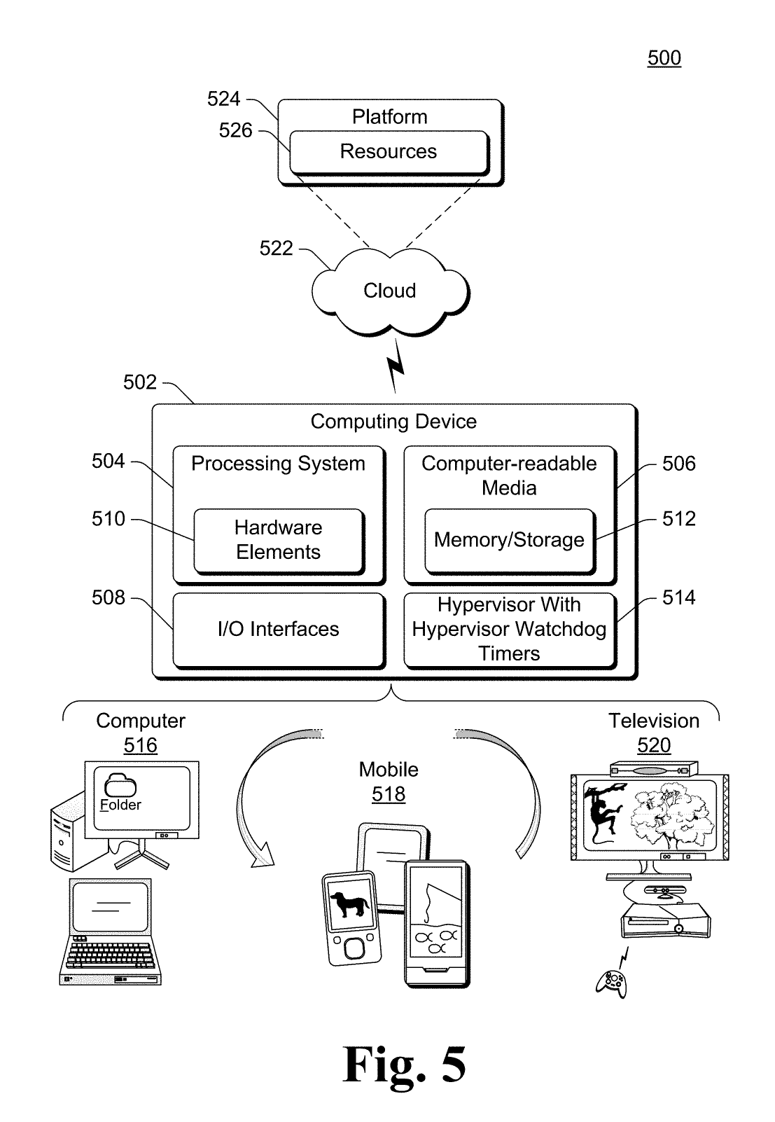

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Resistive RAM (ReRAM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

The computing device 502 also includes hypervisor with hypervisor watchdog timers 514. The hypervisor with hypervisor watchdog timers 514 provides various watchdog timer functionality to operating systems running in partitions on the computing device 502 as discussed above. The hypervisor with hypervisor watchdog timers 514 can implement, for example, the hypervisor 102 of FIG. 1 or FIG. 2.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a computing device, the method comprising: running a hypervisor on the computing device, the hypervisor managing one or more partitions on the computing device, each of the one or more partitions running an operating system; re-arming, in the hypervisor, a hypervisor watchdog timer associated with a partition in response to a re-arm request from an operating system in the partition; resetting, in response to the hypervisor watchdog timer expiring, the operating system; pausing, in response to the computing device entering a low power mode, the hypervisor watchdog timer; and resuming, in response to the computing device exiting the low power mode, the hypervisor watchdog timer.

Alternatively or in addition to any of the methods described herein, any one or combination of: the method further comprising arming, in the hypervisor, the hypervisor watchdog timer in response to an arm request received from the operating system in the partition prior to receipt of the re-arm request; the hypervisor managing multiple partitions and maintaining multiple hypervisor watchdog timers, each of the multiple hypervisor watchdog timers being associated with one of the multiple partitions; the partition being one of the multiple partitions, and the resetting comprising resetting the operating system in the partition without resetting the operating systems in other partitions of the multiple partitions; the method further comprising stopping the hypervisor watchdog timer in response to a stop request from the operating system in the partition; the computing device having no hardware watchdog timer; the computing device having a hardware watchdog timer, the method further comprising re-arming, by the hypervisor, the hardware watchdog timer, the hardware watchdog timer resetting the hypervisor in response to the hardware watchdog timer expiring; the hypervisor watchdog timer expiring after a first amount of time elapses, the hypervisor watchdog timer expecting a re-arm request within a second amount of time of being armed or re-armed, the hypervisor watchdog timer issuing a non-maskable interrupt to the operating system in response to a third amount of time elapsing, the third amount of time being greater than the second amount of time but less than the first amount of time; the computing device having no hardware watchdog timer; the method further comprising pausing the hypervisor watchdog timer in response to a pause request from the operating system in the partition; the method further comprising maintaining, for a first partition of the one or more partitions, a set of multiple hypervisor watchdog timers, each of the multiple hypervisor watchdog timers being associated with a virtual trust level of the first partition, and for each hypervisor watchdog timer in the set of multiple hypervisor watchdog timers, re-arming the hypervisor watchdog timer in response to a re-arm request from a program running in the virtual trust level associated with the hypervisor watchdog timer.

A computing device comprising: a processor; and computer-readable storage medium having stored thereon multiple instructions that implement a hypervisor and that, responsive to execution by the processor, cause processor to: re-arm a hypervisor watchdog timer associated with a partition in response to a re-arm request from an operating system in the partition, the hypervisor managing one or more partitions on the computing device, each of the one or more partitions running an operating system; reset, in response to the hypervisor watchdog timer expiring, the operating system; pause, in response to the computing device entering a low power mode, the hypervisor watchdog timer; and resume, in response to the computing device exiting the low power mode, the hypervisor watchdog timer.

Alternatively or in addition to any of the computing devices described herein, any one or combination of: the hypervisor watchdog timer expiring after a first amount of time elapses, the hypervisor watchdog timer expecting a re-arm request within a second amount of time of being armed or re-armed, the hypervisor watchdog timer issuing a non-maskable interrupt to the operating system in response to a third amount of time elapsing, the third amount of time being greater than the second amount of time but less than the first amount of time; the computing device having no hardware watchdog timer; the hypervisor managing multiple partitions and maintaining multiple hypervisor watchdog timers, each of the multiple hypervisor watchdog timers being associated with a different one of the multiple partitions, the partition being one of the multiple partitions, and the resetting comprising resetting the operating system in the partition without resetting the operating systems in other partitions of the multiple partitions.

A method implemented in a hypervisor of a computing device, the method comprising: managing one or more partitions on the computing device, each of the one or more partitions running an operating system; re-arming a hypervisor watchdog timer associated with a partition in response to a re-arm request from an operating system in the partition; resetting, in response to the hypervisor watchdog timer expiring, the operating system; pausing, in response to the computing device entering a low power mode, the hypervisor watchdog timer; and resuming, in response to the computing device exiting the low power mode, the hypervisor watchdog timer.

Alternatively or in addition to any of the methods described herein, any one or combination of: the hypervisor watchdog timer expiring after an expiration amount of time elapses, the hypervisor watchdog timer issuing a non-maskable interrupt to the operating system in response to a significant portion of the expiration amount of time elapsing, the significant portion of the expiration amount of time being greater than a re-arm amount of time for the hypervisor watchdog timer but less than the expiration amount of time; the computing device having no hardware watchdog timer; the hypervisor managing multiple partitions and maintaining multiple hypervisor watchdog timers, each of the multiple hypervisor watchdog timers being associated with one of the multiple partitions; the partition being one of the multiple partitions, and the resetting comprising resetting the operating system in the partition without resetting the operating systems in other partitions of the multiple partitions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a computing device, the method comprising:
running a hypervisor on the computing device, the hypervisor managing one or more partitions on the computing device, each of the one or more partitions running an operating system;
re-arming, in the hypervisor, a hypervisor watchdog timer associated with a partition in response to a re-arm request from an operating system in the partition;
resetting, in response to the hypervisor watchdog timer expiring, the operating system;
pausing, in response to the computing device entering a low power mode, the hypervisor watchdog timer; and
resuming, in response to the computing device exiting the low power mode, the hypervisor watchdog timer.

2. The method as recited in claim 1, further comprising arming, in the hypervisor, the hypervisor watchdog timer in response to an arm request received from the operating system in the partition prior to receipt of the re-arm request.

3. The method as recited in claim 1, the hypervisor managing multiple partitions and maintaining multiple hypervisor watchdog timers, each of the multiple hypervisor watchdog timers being associated with one of the multiple partitions.

4. The method as recited in claim 3, the partition being one of the multiple partitions, and the resetting comprising resetting the operating system in the partition without resetting the operating systems in other partitions of the multiple partitions.

5. The method as recited in claim 1, further comprising stopping the hypervisor watchdog timer in response to a stop request from the operating system in the partition.

6. The method as recited in claim 1, the computing device having no hardware watchdog timer.

7. The method as recited in claim 1, the computing device having a hardware watchdog timer, the method further comprising re-arming, by the hypervisor, the hardware watchdog timer, the hardware watchdog timer resetting the hypervisor in response to the hardware watchdog timer expiring.

8. The method as recited in claim 1, the hypervisor watchdog timer expiring after a first amount of time elapses, the hypervisor watchdog timer expecting a re-arm request within a second amount of time of being armed or re-armed, the hypervisor watchdog timer issuing a non-maskable interrupt to the operating system in response to a third amount of time elapsing, the third amount of time being greater than the second amount of time but less than the first amount of time.

9. The method as recited in claim 8, the computing device having no hardware watchdog timer.

10. The method as recited in claim 1, further comprising pausing the hypervisor watchdog timer in response to a pause request from the operating system in the partition.

11. The method as recited in claim 1, further comprising:
maintaining, for a first partition of the one or more partitions, a set of multiple hypervisor watchdog timers, each of the multiple hypervisor watchdog timers being associated with a virtual trust level of the first partition; and
for each hypervisor watchdog timer in the set of multiple hypervisor watchdog timers, re-arming the hypervisor watchdog timer in response to a re-arm request from a program running in the virtual trust level associated with the hypervisor watchdog timer.

12. A computing device comprising:
a processor; and
computer-readable storage medium having stored thereon multiple instructions that implement a hypervisor and that, responsive to execution by the processor, cause processor to:
re-arm a hypervisor watchdog timer associated with a partition in response to a re-arm request from an operating system in the partition, the hypervisor managing one or more partitions on the computing device, each of the one or more partitions running an operating system;
reset, in response to the hypervisor watchdog timer expiring, the operating system;
pause, in response to the computing device entering a low power mode, the hypervisor watchdog timer; and
resume, in response to the computing device exiting the low power mode, the hypervisor watchdog timer.

13. The computing device as recited in claim 12, the hypervisor watchdog timer expiring after a first amount of time elapses, the hypervisor watchdog timer expecting a re-arm request within a second amount of time of being armed or re-armed, the hypervisor watchdog timer issuing a non-maskable interrupt to the operating system in response to a third amount of time elapsing, the third amount of time being greater than the second amount of time but less than the first amount of time.

14. The computing device as recited in claim 13, the computing device having no hardware watchdog timer.

15. The computing device as recited in claim 12, the hypervisor managing multiple partitions and maintaining multiple hypervisor watchdog timers, each of the multiple hypervisor watchdog timers being associated with a different one of the multiple partitions, the partition being one of the multiple partitions, and the resetting comprising resetting the operating system in the partition without resetting the operating systems in other partitions of the multiple partitions.

16. A method implemented in a hypervisor of a computing device, the method comprising:
managing one or more partitions on the computing device, each of the one or more partitions running an operating system;
re-arming a hypervisor watchdog timer associated with a partition in response to a re-arm request from an operating system in the partition;
resetting, in response to the hypervisor watchdog timer expiring, the operating system;
pausing, in response to the computing device entering a low power mode, the hypervisor watchdog timer; and
resuming, in response to the computing device exiting the low power mode, the hypervisor watchdog timer.

17. The method as recited in claim 16, the hypervisor watchdog timer expiring after an expiration amount of time elapses, the hypervisor watchdog timer issuing a non-maskable interrupt to the operating system in response to a significant portion of the expiration amount of time elapsing, the significant portion of the expiration amount of time being greater than a re-arm amount of time for the hypervisor watchdog timer but less than the expiration amount of time.

18. The method as recited in claim 17, the computing device having no hardware watchdog timer.

19. The method as recited in claim 16, the hypervisor managing multiple partitions and maintaining multiple hypervisor watchdog timers, each of the multiple hypervisor watchdog timers being associated with one of the multiple partitions.

20. The method as recited in claim 19, the partition being one of the multiple partitions, and the resetting comprising resetting the operating system in the partition without resetting the operating systems in other partitions of the multiple partitions.
